(19) United States
(12) Patent Application Publication
(10) Pub. No.: US 2004/0021021 A1
(43) Pub. Date: Feb. 5, 2004

(54) Pulverizer

(75) Inventor: Tsuyoshi Ishikawa, Tochigi (JP)

Correspondence Address: BACON & THOMAS, PLLC, 625 SLATERS LANE, FOURTH FLOOR, ALEXANDRIA, VA, 22314

(73) Assignee: Mitsui Mining Company, Limited, Tokyo (JP)

(21) Appl. No.: 10/365,401

(22) Filed: Feb. 13, 2003

(30) Foreign Application Priority Data
Aug. 2, 2002 (JP) 2002-225988

(51) Int. Cl. B02C 17/16

(52) U.S. Cl. 241/172

(57) ABSTRACT

The present invention includes a grinding container; a separator provided in the grinding container for separating the grinding container into two chambers of an inner chamber and an outer chamber and having, at least in part, a clearance that connects the chambers; a stirrer rotatably provided in the inner chamber; a supply port for supplying a processing object into the inner chamber; and a discharge port for discharging the processing object from the outer chamber. The stirrer includes a disc rotatably provided in the inner chamber and a plurality of rotating arms provided on both sides of the disc. The disc has a plurality of openings that passes through opposite sides thereof. The inner chamber has therein a plurality of fixed arms facing the rotating arms.

### BACKGROUND OF THE INVENTION

1. Field of the Invention

The present invention relates to a pulverizer, and more particularly, to a continuous media-stirring wet pulverizer, which is effective in dispersing ink and paint, and pulverizing and dispersing ceramic, metal, inorganic substances, organic substances, magnetic substances, pigments, and pharmaceuticals.

2. Description of the Related Art

There are various types of continuous media-stirring wet pulverizer used for dispersing ink and paint, and pulverizing and dispersing ceramic, metal, inorganic substances, organic substances, magnetic substances, pigments, and pharmaceuticals, one example of which is disclosed in Japanese Unexamined Patent Application Publication No. 10-230182.

As shown in FIG. 3, this pulverizer 31 includes a cylindrical grinding container 32 whose both ends are closed; a cylindrical separator 43 provided in the grinding container 32 for separating the inside of the grinding container 32 in the radial direction into two chambers of an inner chamber 39 and an outer chamber 40, and having, at least in part, a plurality of slits 47 that communicates between both chambers 39 and 40; a stirrer 48 provided in the inner chamber 39 in a rotatable manner; a supply port 41 for supplying an processing object into the inner chamber 39; and a discharge port 41 for discharging the processing object from the outer chamber 40.

In this case, the stirrer 48 is shaped like a cylinder, having recessed portions 49 and projecting portions 50 alternately on the outer peripheral surface, and having through-holes 51 in the cylindrical part, through which the processing object and grinding media flow between the inside and outside of the grinding container 32. The ratio of the axial length and the diameter of the grinding container 32 (length/diameter) is set to 1.0 or less.

The pulverizer 31 with such an arrangement makes the most of the separator 43 that has the stirrer 48 having large rotation and an effective area to efficiently disperse, grind, and discharge the processing object using grinding media. In this case, the grinding media fill between the stirrer 48 and the separator 43 by centrifugal force, causing a gap between the respective motions of the grinding media by the friction generated at the separator 43 on the outer periphery and the torque of the stirrer 48, wherein the gap applies shearing, friction, and compression to the processing object, thus remarkably contributing to grinding. The occurrence of the gap depends on the gap between the separator 43 and the stirrer 48, the torque, the friction coefficient and viscosity of the processing object, particularly, the viscosity being very influential.

However, in the pulverizer 31 with such an arrangement, since the shape of stirrer 48 is cylindrical and continuous, entrainment of grinding media occurs depending on the rotational speed in the case of high viscosity, thus not easily causing the gap. Therefore, the operating efficiency of shearing or the like is lowered to obstruct the grinding and dispersing processes. The smaller the grinding media are, the more noticeable this tendency is, thus lowering the grinding efficiency significantly.

### SUMMARY OF THE INVENTION

The present invention has been made to solve the above problems. Accordingly, it is an object of the present invention to provide a pulverizer capable of generating a gap between the respective motions of even high-viscosity grinding media, and applying shearing, friction, compression and so on to a processing object, thereby improving grinding efficiency significantly.

In order to solve the above problems, a pulverizer according to the present invention comprises: a grinding container; a separator provided in the grinding container for separating the grinding container into two chambers of an inner chamber and an outer chamber and having, at least in part, a clearance that connects both the chambers; a stirrer rotatably provided in the inner chamber; a supply port for supplying a processing object into the inner chamber; and a discharge port for discharging the processing object from the outer chamber; the inner chamber housing grinding media; wherein the stirrer includes a disc rotatably provided in the inner chamber and having an opening; and a plurality of rotating arms provided on both sides of the disc. The pulverizer employs an arrangement in which the inner chamber includes fixed arms inside thereof, the fixed arms facing the rotating arms. The pulverizer further employs an arrangement in which the grinding container is shaped like a cylinder whose opposite ends are closed, wherein letting the axial length be L and the diameter be D, the ratio (L/D) of the length (L) and the diameter (D) is 1.0 or less.

Since the present invention employs such an arrangement, a disc and rotating arms rotate with a stirrer, and so grinding media that are subjected to centrifugal force, torque, or vertical and lateral motions move while making a collision or rotation to crash the processing object sandwiched between the grinding media. Also, the disc and the rotating arms directly crash the processing object by the shearing operation or the like. The processing object is separated from the grinding media by the separator while being subjected to the grinding operation, flows from the inner chamber to the outer chamber through the separator, and is discharged through the discharge port to the outside of the grinding container.

### BRIEF DESCRIPTION OF THE DRAWINGS

FIG. 1 is a schematic sectional view of a pulverizer according to an embodiment of the present invention;

FIG. 2 is an explanatory view showing the positional relationship between rotating arms of a disc and fixed arms of a grinding container of the pulverizer shown in FIG. 1; and

FIG. 3 is a schematic sectional view of an example of a conventional pulverizer.

### DESCRIPTION OF THE PREFERRED EMBODIMENTS

The present invention is a modification of a stirrer of a pulverizer disclosed in Japanese Unexamined Patent Application Publication No. 10-230182. A stirrer of the present invention is as follows:

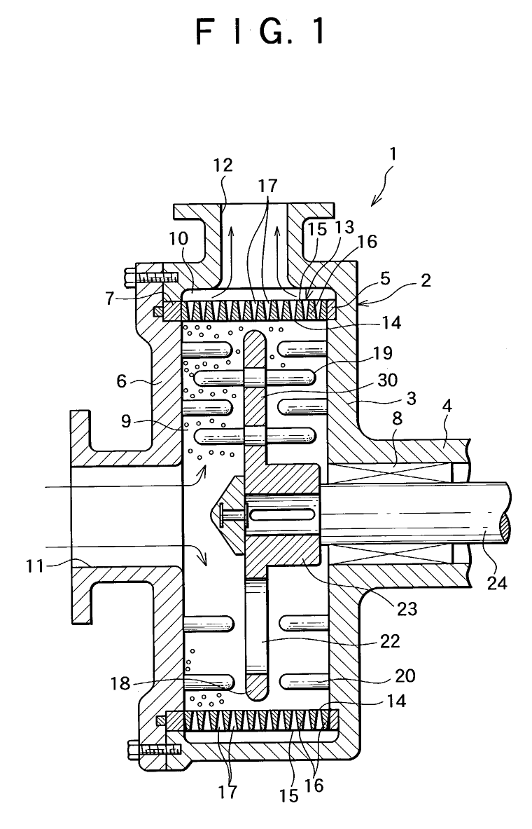

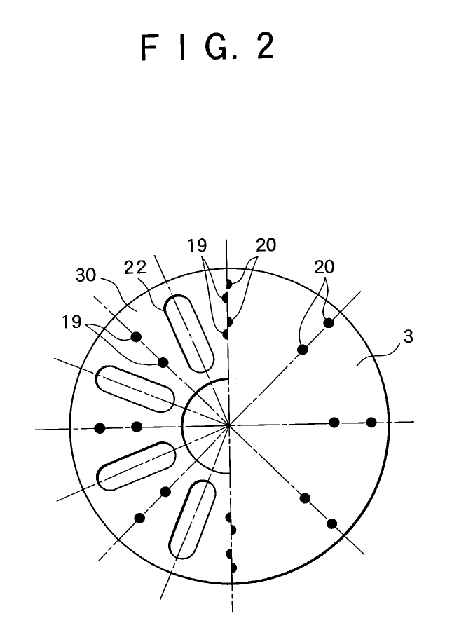

Referring to FIGS. 1 and 2, a disc 30 is mounted in the center of an inner chamber 9 such that it is rotatably fixed to a rotary shaft 24, the disc 30 being partly opened, through which a processing object and grinding media can move between both sides of the disc 30. A plurality of rotating arms 19 is arranged so as to project from both sides of the disc 30. Also, fixed arms 20 are arranged so as to face the rotating arms 19 such that they project from the side of the inner chamber 9 (the side and a cover plate 6 of a container body 3). The fixed arms 20 and the rotating arms 19 are not brought into contact with each other.

The disc 30 is mounted substantially perpendicularly with respect to the rotary shaft 24 through a boss 23. However, if not necessary, the disc 30 may be mounted directly to the rotary shaft 24. Preferably, the disc 30 is shaped like a circular plate and the openings 22 of the disc 30 are not one-sided in the disc 30 but are arranged uniformly on the whole surface. Furthermore, at least one fixed arm 20 is preferably passed through the opening 22 of the disc 30 during the rotation of the disc 30. Providing the opening 22 in this position changes the movement of the processing object or the grinding media not only as a passage, contributing to more effective grinding. The disc 30 or the boss 23 is detachable from the rotary shaft 24.

The rotating arms 19 may be arranged on the whole surface of the disc 30 in view of effective use of the inside of the inner chamber 9; however, preferably, a large number or the concentration of rotating arms 19 are arranged near the outer periphery in the inner chamber 9 so as to work in a high-energy-density position. More preferably, the rotating arms 19 are arranged in the position outside a half of the outer diameter of the disc 30. Also, it is preferable to arrange the rotating arms 19 on the same positions on both sides of the disc 30 and uniformly in the circumferential direction. The rotating arms 19 are mounted substantially perpendicularly to the disc 30. In other words, the rotating arms 19 are arranged in substantially parallel to the rotary shaft 24, and move with the rotation of the rotary shaft 24 to revolve around it. The rotating arms 19 are preferably shaped like a bar.

The fixed arms 20 are secured to the side and the cover plate 6 of the container body 3 in substantially parallel to the rotating arms 19, that is, in substantially parallel to the rotary shaft 24. Accordingly, even when the rotating arms 19 rotate around the rotary shaft 24, they are not brought into contact with the fixed arms 20. The fixed arms 20 are preferably shaped like a bar as in the rotating arms 19.

Preferably, the rotating arms 19 are arranged to face the fixed arms 20 such that they engage with and fit to each other when the disc 30 rotates to revolve the rotating arms 19. For example, they are arranged alternately in the order of the rotating arm 19, the fixed arm 20, the rotating arm 19, and the fixed arm 20 from the center toward the exterior in the radial direction so that the respective ends of the arms 19 and 20 are fitted to reach the bases of the arms 19 and 20.

The above modification of the stirrer has produced the following effects.

(1) Since the stirrer 18 is not cylindrical continuous body and each rotating arm 19 is shaped like a projection, the plurality of rotating arms 19 can easily be arranged in any positions on both sides of the disc 30 in the inner chamber 9, the rotating arms 19 are revolved in the inner chamber 9 to apply strong effects of forced (direct) shearing, friction, and compression to the processing object. Also, the grinding media collide with the disc 30 or the arms 19 and 20 in the inner chamber 9 to obtain centrifugal force and torque, and so obtain vertical and lateral motions, that is, omnidirectional motions, thereby applying shearing, frictional, and compressing effects to the processing object. Accordingly, a high-viscosity processing object can efficiently be dispersed and ground by an increase in the forced operation by the rotating arms 19 or a decrease in the entrainment phenomenon of the grinding media.

(2) The stirrer 18 includes both the disc 30 and the rotating arms 19, so that it can make the most of forced action by the arms 19 and 20, as principle action, and indirect action including moving stress by the disc 30. Also, since the rotating arms 19 have high centrifugal force, efficient dispersion and grinding with less energy loss can be performed by arranging a large number of or the concentration of rotating arms 19 near the outer periphery in the inner chamber 9 so as to work in a high-energy-density position. In addition, efficient dispersion and grinding can be performed irrespective of viscosity by the strong effects of forced (direct) shearing, friction, and compression by the rotating arms 19 to the processing object.

(3) Since the fixed arms 20 are arranged in correspondence with the rotating arms 19, the effects of (1) and (2) further increase.

(4) The openings 22 are provided on the disc 30 to form a passage of a processing object, thereby allowing the supply of the processing object and grinding media to both sides of the disc 30. Accordingly, the rotating arms 19 are disposed on both sides of the disc 30 and are decreased in length, and so the strength of the rotating arms 19 is increased, and because the balance during rotation is improved, the life of the disc 30 is also increased. Arranging the fixed arms 20 in the positions where the openings 22 pass through further changes the motion of the processing object and the grinding media, thus contributing to more effective grinding.

(5) Providing the disc 30 and mounting the rotating arms 19 on the disc 30 significantly increase a footprint to which the rotating arms 19 can be mounted as compared with a case of mounting the rotating arms 19 directly to the rotary shaft, and also the rotating arms 19 can be arranged anywhere on the disc 30, so that the layout and the number of the rotating arms 19 can be determined depending on the processing object.

(6) Since the ratio L/D of the grinding container 2 is set small (1.0 or less) and the diameter is increased by an amount corresponding to the axially decreased length to ensure a grinding area, large centrifugal force can be applied to the stirrer 18 by arranging the stirrer 18, particularly, the rotating arms 19 near the outer periphery in comparison of the size of the grinding container 2. Therefore, a processing object can effectively be ground by efficient use of power. Also, since the separator 13 is provided on the perimeter, the effective area of the separator 13 can sufficiently be ensured to allow efficient processing of a large amount of flowing processing object.

An embodiment of the present invention will be described hereinafter with reference to the drawings.

FIGS. 1 and 2 show an embodiment a pulverizer according to the present invention. The pulverizer 1 is a continuous media-stirring wet pulverizer, including a cylindrical grinding container 2 whose both ends are closed; the stirrer 18 provided in a grinding container 2 in a rotatable manner for stirring a processing object and grinding media in the grinding container 2; and a cylindrical separator 13 provided in the grinding container 2 for separating the processing object and the grinding media in the grinding container 2.

The grinding container 2 includes a cylindrical container body 3 having a closed end and a disc-shaped cover plate 6 mounted to the other opening of the container body 3 for closing it. A cylindrical boss 4 for communicating the inside and outside of the container body 3 is integrally formed in the center of the closed end of the container body 3, in the center of the boss 4 the rotary shaft 24 is rotatably arranged through a shaft bearing 8. The stirrer 18 is integrally mounted to the rotary shaft 24 in the grinding container 2, and is rotatable with the rotary shaft 24.

The grinding container 2 includes the cylindrical separator 13 in an almost axially coincidence with the grinding container 2. The separator 13 separates the inside of the grinding container 2 in the radial direction into two chambers of the inner chamber 9 and the outer chamber 10.

The cover plate 6 is integrally provided with a cylindrical supply port 11 for communicating the inside and outside of the inner chamber 9, in the center thereof, through which the processing object is supplied into the inner chamber 9. The container body 3 is integrally provided with a cylindrical discharge port 12 for communicating the inside and outside of the outer chamber 10, on the side thereof, through which the processing object that has passed through the separator 13 is discharged to the exterior of the grinding container 2.

The separator 13 has only to be capable of separating a processing object of a predetermined size, for example, being formed of an inner ring 14, an outer ring 15, and a plurality of steel bars 16 of wedge-shaped-section provided between the rings 14 and 15. The widths of the steel bars 16 are larger near the inner diameter than near the outer diameter, and are disposed at regular intervals throughout between the outer ring 15 and the inner ring 14. Providing the steel bars 16 between the inner ring 14 and the outer ring 15 forms wedge-shaped slits 17 such that the spacing between the adjacent steel bars 16 and 16 increases from the inner diameter to the outer diameter. The slits 17 are formed all over the circumference.

The grinding container 2 is formed to be short in the axial direction. In other words, letting the axial length be L and the diameter be D, the ratio L/D is set to be 1.0 or less. However, since the diameter D is increased by a decreased amount of the length L, the capacity of the inner chamber 9 can sufficiently be ensured.

The stirrer 18 includes the circular-plate disc 30, a cylindrical boss 23 integrally formed in the center of the disc 30, the round-bar-shaped rotating arms 19 integrally formed on both sides of the disc 30, and mounted to the end of the rotary shaft 24 positioned in the inner chamber 9 of the grinding container 2 through the boss 23.

The disc 30 has the oblong openings 22 that pass through both sides at regular intervals in a plurality of positions (eight in this embodiment) in the circumferential direction, through which a processing object and grinding media can move between both sides of the disc 30. It is recommended that the openings 22 be arranged in the position where the rotating arms 19 are not arranged and at least one fixed arm 20, which will be described later, passes through during the rotation of the disc 30.

The plurality of rotating arms 19 are each disposed at regular intervals in the circumferential direction on both sides of the disc 30. In this embodiment, the disc 30 is equally divided in the circumferential direction into eight, each of which is provided with two rotating arms 19, a total of 16. In this case, the inner rotating arms 19 and the outer rotating arms 19 are positioned on two concentric circles having different diameters around the center of the disc 30, respectively. Each rotating arm 19 is shaped like a round bar, the end of which is chamfered to a hemisphere. Each rotating arm 19 is arranged perpendicularly to the disc 30.

The fixed arms 20 are disposed on the outer periphery side of the rotating arms 19 in the same configuration as the rotating arms 19 so as not to come into contact with the rotating arms 19 when the rotating arms 19 are revolved. The fixed arms 20 are fixed to the side and the cover plate 6 of the container body 3. Each fixed arm 20 is also shaped like a round bar and is chamfered to a hemisphere.

Grinding media include steel, ceramic, glass, and carbide, the diameter of which is on the order of 0.1 to 3 mm. The filling amount is about 20 to 80% of the capacity of the inner chamber 9.

The operation of the above components will be described hereinafter.

First, when a driving source (not shown) is actuated to rotate the rotary shaft 24, the stirrer 18 is rotated with the rotary shaft 24. Then, when a processing object is supplied through the supply port 11 into the inner chamber 9 of the grinding container 2, grinding media that are subjected to centrifugal force, rotation, or vertical and lateral motions by the disc 30 and the rotating arms 19 of the stirrer 18, and the fixed arms 20 on the side wall of the inner chamber 9 move while making a collision or rotation to efficiently crash the processing object sandwiched between the grinding media, and the disc 30 and the rotating arms 19 directly crash the processing object by the shearing operation.

The processing object is separated from the grinding media by the separator 13 while being subjected to the grinding operation when flowing toward the outer periphery side of the inner chamber 9, and flows into each slit 17 of the separator 13, through which reaches the inside of the outer chamber 10, and is discharged from the grinding container 2 through the discharge port 12 from the outer chamber 10.

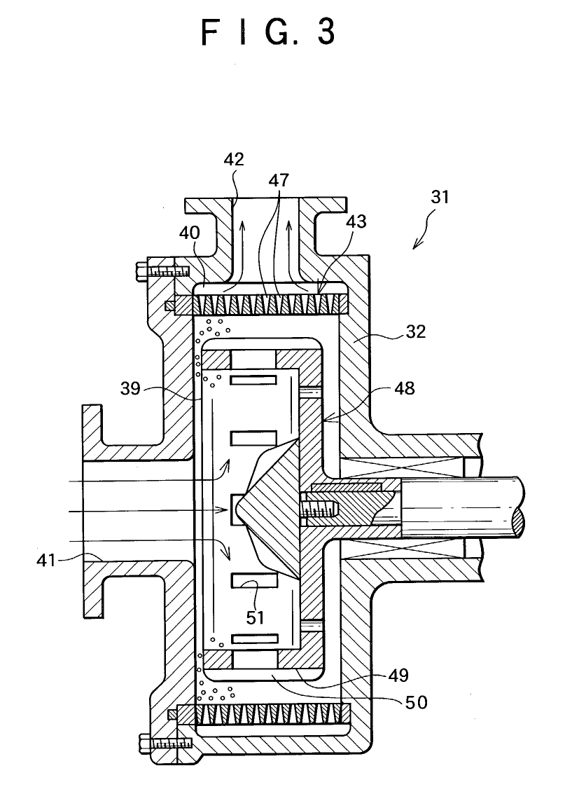

The following are the comparison of the performance of the pulverizer 1 according to the present invention and that of the conventional pulverizer 31.

| | First Embodiment (FIG. 1) | Comparative Example (FIG. 3) |
|---|---|---|
| Motor Capacity: | 15 kW | 15 kW |
| Revolving Speed: | 1200 rpm | 1200 rpm |
| Grinding Container | | |
| Inner Diameter (D): | 230 mm | 230 mm |
| Axial Length (L): | 86 mm | 86 mm |
| Disc Outer Diameter: | 220 mm | (Diameter of Cylinder) |
| | | 196 mm |
| Disc Opening | Circumferential Position: Equally 45° | |
| Rotating Arm Number: | 8 × 2 | |
| | Radial Position: φ 130 mm, φ 180 mm | |
| | Circumferential position: Equally 45° | |
| Fixed Arm | Number: 8 × 2 | |
| | Radial position: φ 155 mm, φ 205 mm | |
| | Circumferential position: Equally 45° | |
| Grinding Media | Diameter: 0.3 mm | 0.3 mm |
| | Weight: 8.1 kg | 8.1 kg |
| | Filling Factor: 76.5% | 72% |

(Filling Factor indicates the ratio of the capacity of media to the capacity of the actual inner chamber)

A mixture of 15-kg calcium carbide (mean grain diameter: 5.5 μm), 15-kg water, and a 75-g dispersant was supplied to each of the pulverizer (first embodiment) of the present invention and the conventional pulverizer and was grinded. As a result, balling efficiency was as follows.

balling efficiency=throughput (kg)/(weight of grinding media (kg)×processing time (min) (unit: kg/kg/min)

TABLE 1

Balling efficiency (kg/kg/mm)

| Average ground | First | First comparative |
|---|---|---|
| particle diameter | embodiment | example |
| 1.4 μm | 0.314 | 0.189 |
| 1.2 μm | 0.247 | 0.157 |
| 1.0 μm | 0.182 | 0.128 |
| 0.9 μm | 0.152 | 0.110 |

The comparison has found that the present invention can perform grinding in a short time, having an excellent grinding performance.

The present invention is constructed as described above, wherein since a plurality of rotating arms is provided on both sides of a disc of a stirrer, a processing object is forcedly subjected to shearing, frictional, and compressing effects by the revolution of the rotating arms in a grinding container. Also, grinding media collide with the disc or the rotating arms to obtain centrifugal force and torque, thus obtaining vertical and lateral omnidirectional motions, which apply shearing, frictional, and compressing effects to a processing object. Accordingly, a high-viscosity processing object can efficiently be dispersed and ground by an increase in the forced operation by the rotating arms or a decrease in the entrainment phenomenon of the grinding media; thus grinding efficiency can remarkably be increased.

The stirrer includes both the disc and the rotating arms, so that it can make the most of forced action by the rotating arms, as principle action, and indirect action including moving stress by the disc. Also, since the rotating arms have high centrifugal force, efficient dispersion and grinding with less energy loss can be performed by arranging a large number of or the concentration of rotating arms near the outer periphery in the inner chamber so as to work in a high-energy-density position. In addition, efficient dispersion and grinding can be performed without influence of viscosity by the strong effects of forced shearing, friction, and compression by the rotating arms to the processing object.

Since fixed arms are arranged on the inner surface of the inner chamber, the aforesaid effects can further be increased.

Since openings are provided on the disc, the openings work as passages of a processing object, thereby allowing the supply of the processing object and grinding media to both sides of the disc Accordingly, the strength of the rotating arms can be increased by decreasing the lengths of the rotating arms disposed on both sides of the disc, and because the balance during rotation can be improved, the durability of the disc can be increased. The motions of the processing object and the grinding media can further be varied by arranging the fixed arms in the positions where the openings pass through, thus allowing more effective grinding.

Since the ratio L/D of the grinding container is set to 1.0 or less, and the diameter is increased by an amount corresponding to the axially decreased length to ensure a grinding area, large centrifugal force can be applied to the stirrer by arranging the stirrer, particularly, the rotating arms near the outer periphery in comparison of the size of the grinding container. Therefore, a processing object can effectively be ground by efficient use of power. Also, since the separator is provided on the perimeter, the effective area of the separator can sufficiently be ensured to allow efficient processing of a large amount of flowing processing object.

What is claimed is:

1. A pulverizer comprising:
a grinding container;
a separator provided in the grinding container for separating the grinding container into two chambers of an inner chamber and an outer chamber and having, at least in part, a clearance that connects both the chambers;
a stirrer rotatably provided in the inner chamber;
a supply port for supplying a processing object into the inner chamber; and
a discharge port for discharging the processing object from the outer chamber; wherein the inner chamber houses grinding media;
wherein the stirrer includes a disc rotatably provided in the inner chamber and having an opening; and a plurality of rotating arms provided on both sides of the disc.

2. A pulverizer according to claim 1, wherein the inner chamber includes fixed arms inside thereof, the fixed arms facing the rotating arms.

3. A pulverizer according to claim 1 or 2, wherein the grinding container is shaped like a cylinder whose opposite ends are closed, wherein letting the axial length be L and the diameter be D, the ratio (L/D) of the length (L) and the diameter (D) is 1.0 or less.
